(19) United States
(12) Patent Application Publication
(10) Pub. No.: US 2009/0228251 A1
(43) Pub. Date: Sep. 10, 2009

(54) Systems and Methods for Designing Optical Surfaces

(75) Inventors: Ozan Cakmakci, Orlando, FL (US); Jannick Rolland, Chuluota, FL (US); Brendan Moore, Venice, FL (US); Hassan Foroosh, Orlando, FL (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: University of Central Florida Research Foundation, Inc., Orlando, FL (US)

(21) Appl. No.: 12/267,992

(22) Filed: Nov. 10, 2008

Related U.S. Application Data
(60) Provisional application No. 60/986,396, filed on Nov. 8, 2007.

(51) Int. Cl. G06F 17/10

(52) U.S. Cl. 703/2

(57) ABSTRACT

In one embodiment, a system and method for designing an optical surface pertain to constructing a matrix of radial basis functions, each column of the matrix corresponding to a radial basis function, selecting an initial surface to be used as a starting point, selecting initial weights for the radial basis functions, generating an initialized optical surface based upon the selected initial surface and initial weights, and optimizing the initialized optical surface to minimize an error function.

### CROSS-REFERENCE TO RELATED APPLICATION

This application claims priority to copending U.S. provisional application entitled “Optimal Local Shape Description for Non-Rotationally Symmetric Optical Surface Design and Analysis” having Ser. No. 60/986,396, filed Nov. 8, 2007, which is entirely incorporated herein by reference.

### BACKGROUND

Rotationally non-symmetric surfaces are sometimes required to achieve desired optical performance characteristics within a restricted volume. Such optical surfaces can include, for example, rotationally non-symmetric freeform surfaces that are provided on lenses, mirrors, or prisms.

Within the optical design community, the de facto standard for describing optical surfaces with rotational non-symmetry has been multivariate polynomials. For example, x-y polynomials and Zernike polynomials are used for designing such optical surfaces. In actuality, polynomial-based solutions are not as desirable as such conventional wisdom would lead one to believe. Given that polynomial functions are global functions, i.e., functions that do not substantially vanish beyond a local area, many overlapping polynomial functions may be required to achieve local characteristics that are desired of a given optical surface. In cases in which the optical surface must comprise many such local characteristics, the number of required polynomial functions increases further still. Furthermore, the Runge phenomenon highlights the fact that the point distribution of the sampled function is important. For example, equally spaced samples of the Runge function

$$\frac{1}{1 + 25 {x}^{2}}$$

do not lead to a satisfactory approximation and increasing the polynomial order does not help in this setting. Although Chebyshev points can be used in this instance to improve the approximation, the fact remains that the point distribution plays an important role in polynomial interpolation.

An alternative approach that can be used to design an optical surface is to divide the surface into intervals and use low-order polynomials, such as cubics, to define each interval for the purpose of approximating a target function. This approach is known as the spline approach. There are several types of splines that can be used in such an approach, including Bezier splines, B-splines, and non-uniform rational B-splines (NURBS). Perhaps the most flexible of those types of splines are NURBS. A p-th degree NURBS curve can be fully defined using control points, knots, and weights. The NURBS curve can be extended to two dimensions using the idea of a tensor-product. The set of control points in two dimensions is called a control mesh. Unfortunately, NURBS solutions are difficult for irregular point sets in three dimensions and not possible for higher dimensions.

In view of the above, it can be appreciated that it would be desirable to have an improved system or method for designing optical surfaces.

### BRIEF DESCRIPTION OF THE FIGURES

The present disclosure may be better understood with reference to the following figures. Matching reference numerals designate corresponding parts throughout the figures, which are not necessarily drawn to scale.

FIG. 1 an illustration of a linear combination of Gaussian radial basis functions approximating a paraboloid.

FIGS. 2A and 2B comprise a flow diagram that illustrates an embodiment of a method for designing an optical surface.

FIG. 3 is a schematic diagram of an optical system that includes an off-axis magnifier.

FIG. 4 is a modulation transfer function of an off-axis magnifier suitable of use in the optical system of FIG. 3, the off-axis magnifier having being designed using a combination of radial basis functions.

FIG. 5 is a first example application for an optical surface designed using a combination of radial basis functions.

FIG. 6 is a second example application for an optical surface designed using a combination of radial basis functions.

FIG. 7 is a block diagram of a computing system that can be used to design an optical surface.

### DETAILED DESCRIPTION

Described herein are embodiments of systems and methods that can be used to design optical surfaces, including complex optical surfaces, such as rotationally non-symmetric and freeform surfaces. In some embodiments, a system and method relate to approximating optical surfaces using a linear combination of radial basis functions. As used herein, the term “radial basis function” denotes a function whose Fourier transform is non-negative and, when shifted to data sites, generates an invertible interpolation matrix (Φ). In other words, a radial basis function is a positive definite function that generates a positive definite, and therefore invertible, interpolation matrix. In at least some cases, such optical surfaces have characteristics superior to those of surfaces designed using other techniques.

As a preliminary matter, reference is made to FIG. 8 and the associated text, which together provide clarification as to terms used in the present disclosure, including the terms “data site”, “data value”, and “evaluation point.”

### Optical Surface Representation

The traditional description of an aspheric optical surface is accepted in the optical design community to be:

$$z ( r ) = \frac{{cr}^{2}}{1 + \sqrt{1 - ( 1 + k ) {c}^{2} {r}^{2}}} + {\sum }_{i = 0}^{n} {a}_{i} {r}^{2 i + 4} \qquad [ Equation 1 ]$$

where c represents the curvature of the surface, r is the \sqrt{x²+y²} radius of the surface, k is the conic constant, and aᵢ represent the polynomial coefficients. Optical surfaces can also be represented as a sum of basis functions as follows:

z(x,y)=Σφᵢ(x,y)wᵢ [Equation 2]

where φᵢ are the basis functions and wᵢ are the coefficients or weights of the basis functions. Three choices for the basis functions φᵢ include polynomials, trigonometric functions, and rational functions.

In the case where a basis function φ is a radial basis function, an optical surface can be written as

$$s ( x ) = {\sum }_{n} φ ( ‖ x - {c}_{n} ‖ ) {w}_{n} \qquad [ Equation 3 ]$$

where x is an evaluation point, cₙ are the centers of the radial basis functions, wₙ are the weights, and ∥·∥ denotes the 2-norm. The translated basis functions in Equation 3 take data into account by shifting the radial basis functions to the data sites. Hence, there are no problems with the implications of the Mairhuber-Curtis theorem, which states that a multivariate basis with a finite number of basis functions and a set of distinct interpolation points may not lead to an invertible interpolation matrix if the basis functions are independent of the data. Significantly, the choice of radial basis functions obviates the need to create a mesh to generate a surface, which can be computationally expensive, and therefore provides a major advantage over other techniques. The basis centers can be placed within a domain Ω⊂R^{s}, s≧1, and a discrete surface is approximated at the points of interest (i.e., the evaluation points). The placement of the basis centers can be uniform, according to Chebyshev points, or even completely random. Composing the basis functions with the 2-norm makes the basis functions spherically radial.

Using the approximation condition s(xᵢ)≈zᵢ, where i=1, 2, . . . m, at m data sites and using n basis functions for s(x) in Equation 3, the approximation at each point xᵢ can be expressed as a dot product. It is possible to express the collection of m products with a matrix-vector multiplication and arrive at the following m by n linear system:

Φₘₓₙw=Z [Equation 4]

where Φₘₓₙ is an mxn matrix, w is a length n vector of weights, and Z is the resulting discrete surface evaluated at the m evaluation points. Each column in the Φₘₓₙ matrix corresponds to a radial basis function, and Φₘₓₙ may be written as

$$Φ = [ \begin{matrix}{φ}_{0} ( {x}_{1} ) & {φ}_{1} ( {x}_{1} ) & … & {φ}_{n} ( {x}_{1} ) \\ {φ}_{0} ( {x}_{2} ) & {φ}_{1} ( {x}_{2} ) & … & {φ}_{n} ( {x}_{2} ) \\ ⋮ & ⋮ & ⋱ & ⋮ \\ {φ}_{0} ( {x}_{m} ) & {φ}_{1} ( {x}_{m} ) & … & {φ}_{n} ( {x}_{m} )\end{matrix} ] \qquad [ Equation 5 ]$$

One can assume that Φ is positive definite and that m=n. In this case, the connection between the choice of φ and a desired positive definite interpolation matrix Φ is provided by the Bochner theorem. An important practical implication of the Bochner theorem is that the translated versions of a positive definite function φ indeed generate a positive definite Φ matrix. A function is positive definite if it has a nonvanishing Fourier transform. A matrix A is positive definite if u^{T} Au≧0 for all uεR^{s}. Positive definite matrices have positive eigenvalues, and therefore positive definite matrices are invertible. The theory developed by Micchelli, using the results of Bochner, covers the case in which the basis centers and the data sites coincide (i.e., a symmetric and positive definite interpolation matrix Φ).

Examples of radial basis functions include Gaussian functions and inverse multiquadric functions (i.e., β>0 in Table 1). Thin-plate splines are conditionally positive definite. The mathematical expressions for each of those functions are given in Table 1.

TABLE 1

| Function | Mathematical Expression |
|---|---|
| Gaussian | φ(x) = e^{-ε}^{²}^{∥x∥}^{₂}^{²}, x ∈ R^{s} |
| Inverse Multiquadric | φ(x) = (1 + ε² ∥ x ∥²)^{-β} x ∈ R^{s}, β ∈ R\N₀ |
| Thin-plate spline | φ(x) = ∥ x ∥^{2β} log(∥ x ∥), x ∈ R^{s}, β ∈ N |

Other radial basis functions include compactly supported radial basis functions, such as the Wendland function and the Wu function.

Given a particular surface Z, a selection of a radial basis function, a selection of basis centers and data sites, and a shape factor in the case of a Gaussian or an inverse multiquadric, the vector w can be found using least squares with the following relation

w=(Φ^{T}Φ)⁻¹Φ^{T}Z [Equation 6]

where Φ^{T} denotes the transpose of the Φ matrix.

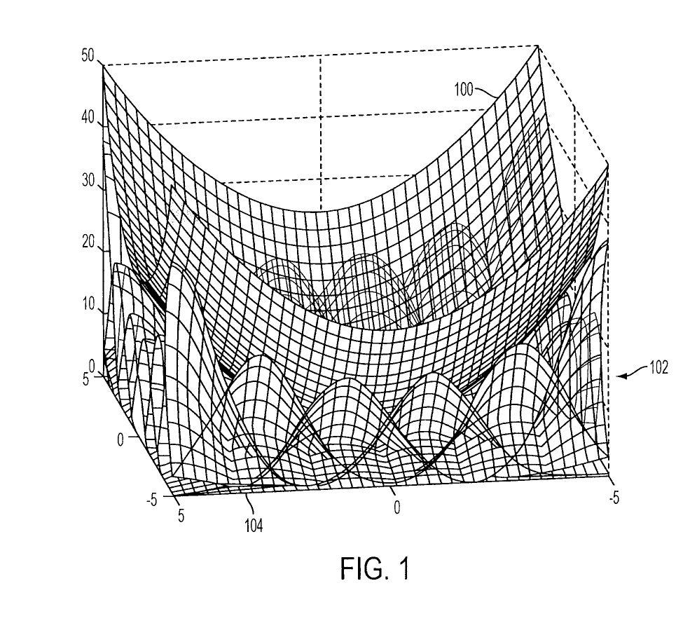

FIG. 1 illustrates how radial basis functions can be used to represent a surface. More particularly, shown is approximation of a known paraboloid 100 using 36 two dimensional (2D) Gaussian radial basis functions. In the example of FIG. 1, the paraboloid 100 has been discretized into a grid 104 of 20×20 points and the basis centers of the 36 Gaussians have been uniformly spaced within the domain. The linear combination of Gaussian radial basis functions 102 approximate the paraboloid 100. Although representation of a paraboloid is illustrated in FIG. 1 and has been described herein, substantially any surface can be similarly represented using a linear combination of radial basis functions.

### Optical Design Using Radial Basis Functions

As is apparent from the above discussion, radial basis functions can be used to represent or approximate a known optical surface. In the optical design context, the shape of the optical surface is unknown at the starting point of the optimization. That shape can be determined, however, given that the optical characteristics desired from the surface are known for a given application. As is described in the following, the shape can be determined using radial basis functions by optimizing with an error function that provides an indication of the error of the optical surface in achieving the desired characteristics.

One aspect of the design process relates to selection of the number of radial basis functions that will be used. Generally speaking, the number of radial basis functions that is most appropriate may depend upon the nature of the optical surface that is desired. In at least some cases, the more simple the optical surface being designed, the smaller the number of basis functions that may be necessary. In some embodiments, the number of basis functions needed to solve an optical design problem can be found by trial and error.

A starting point, i.e., an initial surface, can also be selected. In some cases, a spherical surface may be an appropriate starting point. As with the number of basis functions, the starting point that is most appropriate may depend upon the nature of the optical surface that is desired. Assuming a base sphere as an initial surface, Equation 2 can be modified to add a base conic as follows:

$$z ( x , y ) = \frac{( {x}^{2} + {y}^{2} )}{1 + \sqrt{1 - ( 1 + k ) {c}^{2} ( {x}^{2} + {y}^{2} )}} + {\sum }_{i} {φ}_{i} ( x , y ) {w}_{i} \qquad [ Equation 7 ]$$

where c is the curvature of the base conic in the x and y directions and k is the conic constant. In alternative embodiments, the initial surface may be represented without the base conic (i.e., represented with only the sum of basis functions). The addition of the base conic, however, facilitates first order raytracing calculations.

A Φ matrix (see Equation 5) can also be created in which each column of the matrix contains a radial basis function as per Equation 3 in vectorized form. Given a number of radial basis functions, the aperture can be divided into xₙᵤₘ pieces in the x dimension and yₙᵤₘ pieces in the y dimension. The number of columns in the matrix can be set by the product of xₙᵤₘ and yₙᵤₘ. The number of rows in the Φ matrix controls the spatial resolution of the radial basis functions and can be set by the designer in accordance with the degree of granularity that is desired. As with the choice of number of basis functions and the initial surface selections, the number of rows that is most appropriate may depend upon the nature of the optical surface that is desired.

In some embodiments, a rectangular aperture can be assumed. It is noted, however, that substantially any other aperture shape may be used since the radial basis functions can be spatially moved. For example, Gaussians can be spatially moved using their basis centers. When Gaussians are used as the radial basis functions, the aperture diameter can be divided into xₙᵤₘ pieces in the x dimension and the x-basis centers can be placed 1/xₙᵤₘ apart from each other. Similarly, the aperture can be divided into yₙᵤₘ pieces in the y dimension and the y-basis centers can be placed 1/yₙᵤₘ apart from each other. The shape factor can be set to 1.

As described above, the optical surface, z, in Equation 2 is unknown a priori in the context of an optical design problem. An iterative optimization process can be used to adjust the weights, wᵢ, from that equation with the goal of reaching a minimum of an error function given the starting point. The error function that is selected may be chosen based upon the nature of the optical surface that is desired. In some embodiments, the error function can relate to the transverse error in the image plane, which is the sum of squares of the deviations of the rays from their respective reference wavelength chief rays. In other embodiments, the error function can relate to the Strehl ratio or the modulation transfer function. The optimization technique that is used may also be chosen based upon the nature of the optical surface that is desired. Suitable optimization techniques may include local or global optimization techniques including, for example, damped least squares, or global optimization such as simulated annealing, genetic algorithms, and particle swarm optimization. Of those techniques, damped least squares is available in several raytracing programs.

Once the error function and optimization techniques have been selected, optimization can be performed to minimize the error function. The result of such optimization is the weights of linear combination, which enable a fabricator to evaluate the surface at any point within the domain and, if desired, generate a sag table.

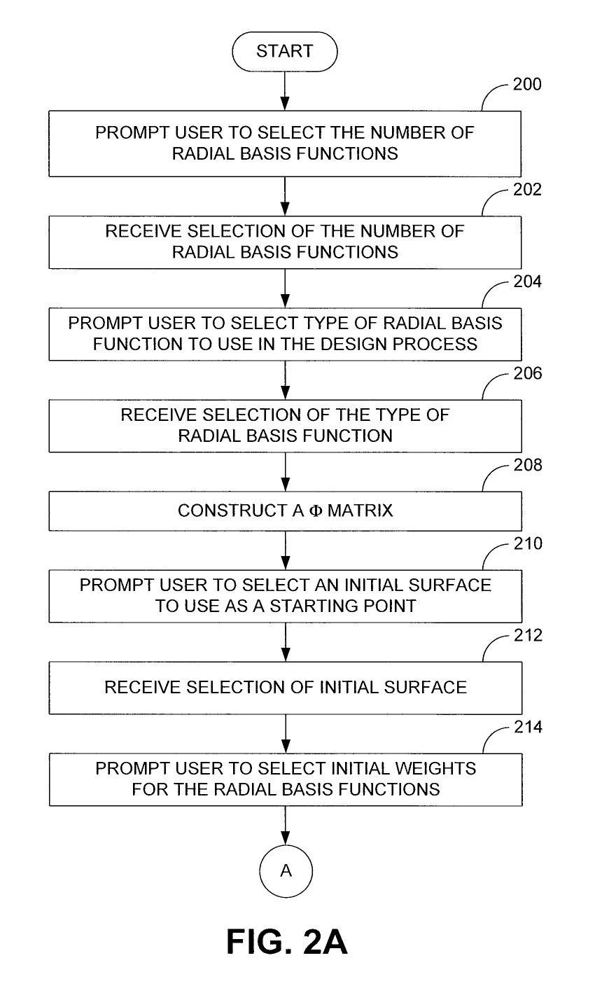

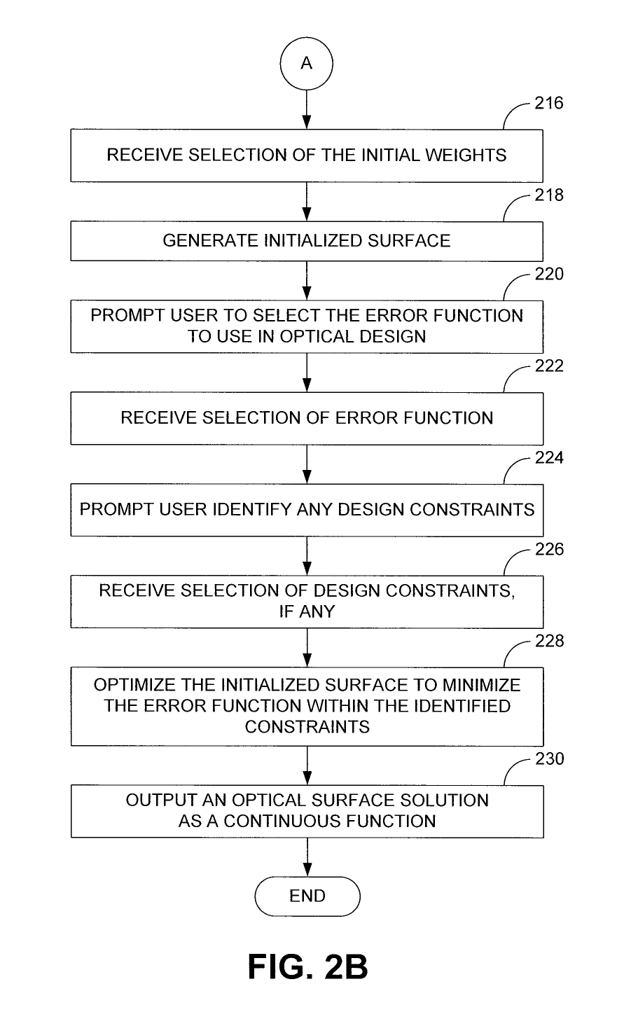

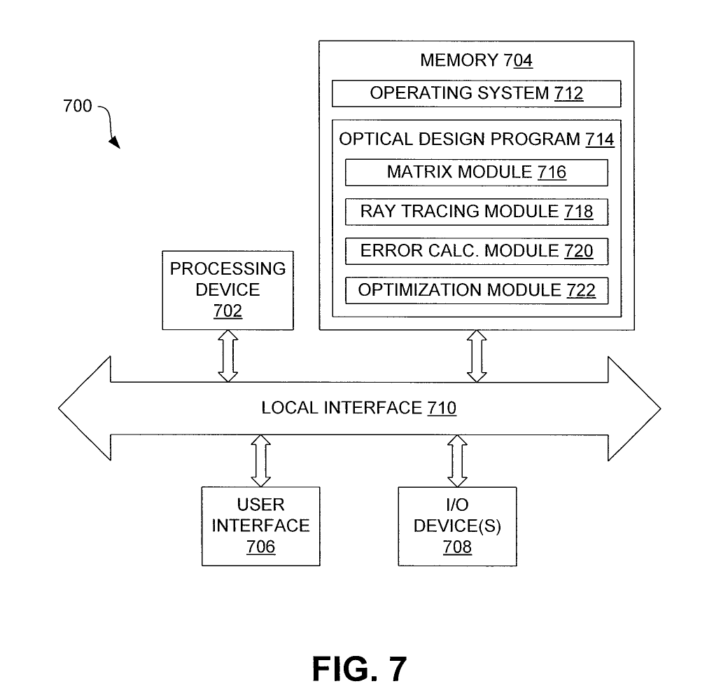

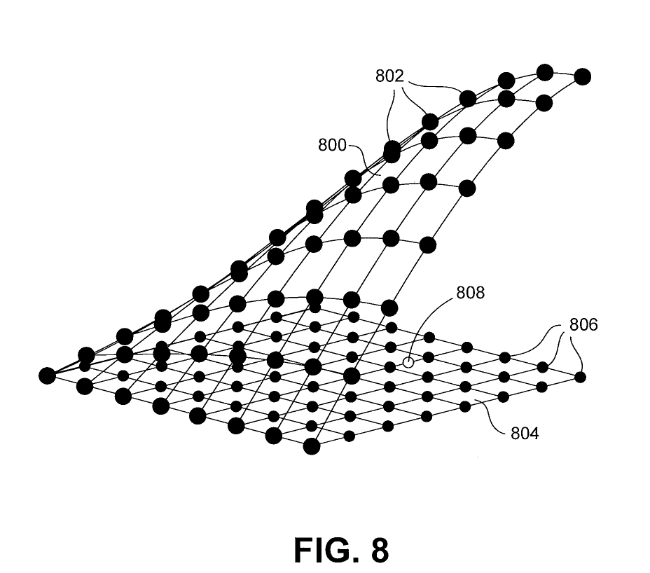

FIGS. 2A and 2B illustrate an example method for designing an optical surface consistent with the above discussion. In some embodiments, the method can be performed, in whole or in part, using an optical design program, such as that identified in relation to FIG. 7 below. It is to be understood that the actions described in relation to the flow diagram of FIGS. 2A and 2B can, at least in some embodiments, be performed in an order other than that illustrated and described.

Beginning with block 200 of FIG. 2A, a user, such as an optical surface designer, is prompted, for example by the optical design program, to select the number of radial basis functions to use in the design process. As described above, the number of basis functions corresponds to the number of columns that will be present in the Φ matrix. In cases in which the program, module, or routine that is used to trace rays (e.g., ray tracing program) traces multiple rays at a time, the user may further select the number of data sites to use in the design process to control the spatial resolution. As also described above, the number of data sites corresponds to the number of rows that will be present in the Φ matrix. Once the number of radial basis functions, and possibly the number of data sites, have been received, as indicated in block 202, the user is prompted to select the type of radial basis function to use in the design process, as indicated in block 204. That selection can then be received, as indicated in block 206. As mentioned in the foregoing, various types of radial basis functions can be used. Examples of such radial basis functions include the Gaussian, multiquadric, and the thin-plate spline functions.

In at least some embodiments, the selections described above may be made by the user based upon the user's skill and experience as well as the user's understanding of what would be most appropriate for the design problem being solved. For example, if the optical surface being designed is relatively simple (e.g., a rotationally symmetric surface), a relatively small number of basis functions and data sites may be deemed appropriate. If, on the other hand, the optical surface is relatively complex (e.g., rotationally non-symmetric, freeform, etc.), a larger number of basis functions and data sites may be deemed appropriate.

Once the above-described user selections have been received, the optical design program constructs a Φ matrix (Equation 5), as indicated in block 208, relative to those selections. Such a matrix can, for example, be generated using an appropriate software program, module, or routine that is, for example, written in C or C++. It is noted that although construction of a matrix is described herein, in the case where ray tracing is performed one ray at a time, the Φ matrix reduces to a single row. In such a case, results can be obtained using a dot product operation. A dot product of two vectors a=[a₁, a₂, . . . aₙ] and b=[b₁, b₂ . . . bₙ] is defined to be

$$a \cdot b = {\sum }_{j} {a}_{j} {b}_{j} = {a}_{1} {b}_{1} + {a}_{2} {b}_{2} + … {a}_{n} {b}_{n} .$$

For the purposes of this disclosure, the action of constructing a Φ matrix includes cases in which rays are traced one at a time and such dot product operations are performed (i.e., instances in which the Φ matrix reduces to a single row). In such a case, the Φ matrix is at least implicitly constructed, albeit one row at a time.

Each time a ray intersects a surface described using radial basis functions, the location of the ray-surface intersection is stored in a vector. Each component in a vector contains a dimension. For example, the first component is the x-dimension and the second component is the y-dimension and so on. The Eucledian distance (i.e., the 2-norm) between the ray-surface intersection and each of the basis center locations can be computed. The Eucledian norm ∥x∥ of a vector x=x₁, x₂, . . . xₙ is defined to be \sqrt{x₁²+x₂²+ . . . +xₙ²}. Then, for each column in the Φ matrix, the radial basis function can be evaluated using the computing difference vector representing the basis center and the evaluation point.

With reference next to block 210, the user is prompted to select an initial surface to use as a starting point and, as indicated in block 212, the selection is received. As described above, the initial surface can be selected by the user relative to the optical surface problem that is to be solved. By way of example, the starting point may be a base conic (e.g., sphere, parabola, hyperbola, ellipse), a flat surface, or a low order polynomial. Next, the optical design program prompts the user to select the initial weights, wᵢ, for the radial basis functions, as indicated in block 214, and the selected weights are received, as indicted in block 216 of FIG. 2B. As also described above, the weights can be initialized by, for example, setting w in Equation 4 to zero. Notably, however, the user could choose alternative (i.e., non-zero) weights based upon domain specific knowledge or experience. Once the user selections regarding the initial surface and initial weights have been received, the optical design program generates an initialized surface, as indicated in block 218.

At this point, iterative optimization can be performed. Before such optimization is performed, the user is prompted to select an error function, as indicated in block 220, and a selected error function is received, as indicated in block 222. Again, the selection may be made based upon the skill and experience of the optical surface designer and may be dependent upon the problem that is being solved. Appropriate error functions may, for example, relate to the transverse error, the Strehl ratio, or the modulation transfer function. Notably, alternative error functions can be constructed when solving non-imaging optics problems. In addition to selecting the error function, any design constraints can be identified. Therefore, the user can be prompted to identify the design constraints, as indicated in block 224, and the design constraints can be received, as indicated in block 226. Such design constraints may relate to focal length, distortion, thickness constraints (e.g., for a lens), packaging constraints, surface boundaries, and so forth. Identification of such constraints limits the number of possible solutions to the optical surface design problem and ensure that the application requirements are met.

Next, with reference to block 228, the initialized surface defined by the user selections is optimized to minimize the error function within the identified constraints, if any. As described above, various optimization techniques can be employed and the technique that is used may be selected by the user based upon his or her skill and experience relative to the problem to be solved. Suitable optimization techniques may include local or global optimization techniques such as damped least squares, simulated annealing, genetic algorithms, and particle swarm optimization. During optimization, different weights are used to define multiple optical surfaces, and each optical surface is individually evaluated relative to the selected error function to determine which is best in terms of minimizing error. Therefore, an iterative approach is used in which the program, module, or routine repeatedly changes the weights (w) of the radial basis functions, calculates a new surface (Z) using the new weights, and the error of the new surface is calculated using the error function. With such a process, the best optical surface for the given problem, as well as the various weights associated with that surface, can be identified. Through such identification, a solution can be output in the form of a continuous function (block 230) that may be utilized by an optics fabricator. As described above, the weights enable a fabricator to evaluate the optical surface at any point and, if desired, generate a sag table. At least in the case of a Gaussian radial basis function, the solution is continuously differentiable because that solution results from a linear combination of radial basis functions and therefore requires no stitching together of functions or other actions that can complicate such fabrication.

It is noted that although various selections are described as being made by a human user, the optical design program may make the selections on behalf of the user. For example, in some embodiments, one or more of the number of radial basis functions, number of data sites, type of radial basis functions, initial surfaces, initial weights, error functions, and design constraints can be “selected” by the optical design program as a default. Furthermore, as used herein, “selecting” extends to the optical design program making a selection responsive to a selection input by a human user.

### Testing of the Local Basis Function Approach

As a test case, a system with a single on-axis field was optimized to determine whether a parabola represented by the linear combination of Gaussian radial basis functions resulted. A user-defined type 1 surface was set up for the test case with a 6×6 grid of uniformly distributed basis centers having 112 user-defined coefficients. The first coefficient represented the x curvature of the base sphere, the second coefficient represented the conic constant in the x direction, the third coefficient represented the conic constant in the y direction, and the fourth coefficient represented the aperture size. The next 36 coefficients were the weights wᵢ of the Gaussian radial basis functions, and the last 72 coefficients contained the x and y basis centers of the Gaussian radial basis functions. The basis centers were frozen (i.e., were not variable) during optimization runs. Basis centers were included in the user coefficient array solely for diagnostics purposes to ensure that the gridding functions were working properly. The variables in the test case included the x and y curvatures, image plane defocus, and the 36 weights of the 6×6 Gaussian radial basis functions across the aperture. The conic constants in x and y direction of the base conic were set to zero and were not varied during optimization. The optimization converged in less than 10 cycles to a parabola with a Strehl ratio of 1, thereby verifying the soundness of the approach.

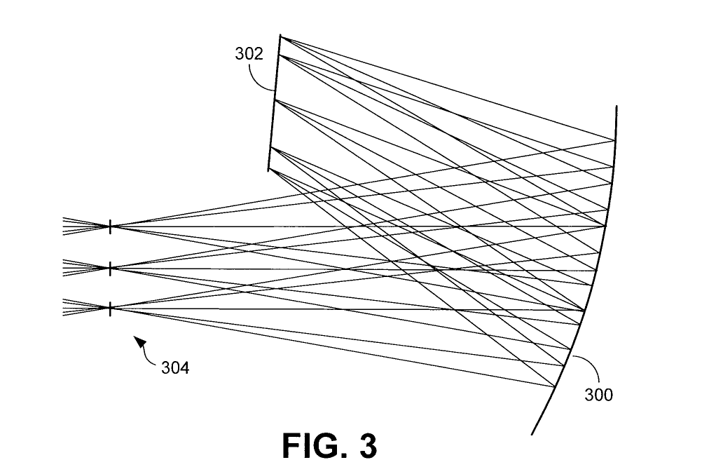

In a second test case, an off-axis magnifier was considered. More particularly, the issue of which shape is optimal for a single surface mirror constrained in an off-axis magnifier configuration was considered. FIG. 3 illustrates the layout of a system that includes an optimal off-axis magnifier 300, which reflects images generated by a microdisplay 302 onto the pupil 304 an observer.

Four systems were designed to address the question of optimal shape for purposes of comparison: a 10th order anamorphic sphere, an x-y polynomial, a 10th order Zernike polynomial, and a linear combination of Gaussian radial basis functions. Each system under comparison operated with a 15 millimeter (mm) eye clearance, 3 mm pupil, a 24 degree diagonal full field of view, and 17 defined field points. Conventional design processes were used for each of the anamorphic sphere, x-y polynomial, and Zernike polynomial solutions. A procedure similar to that described above in relation to FIG. 2 was used for the Gaussian solution.

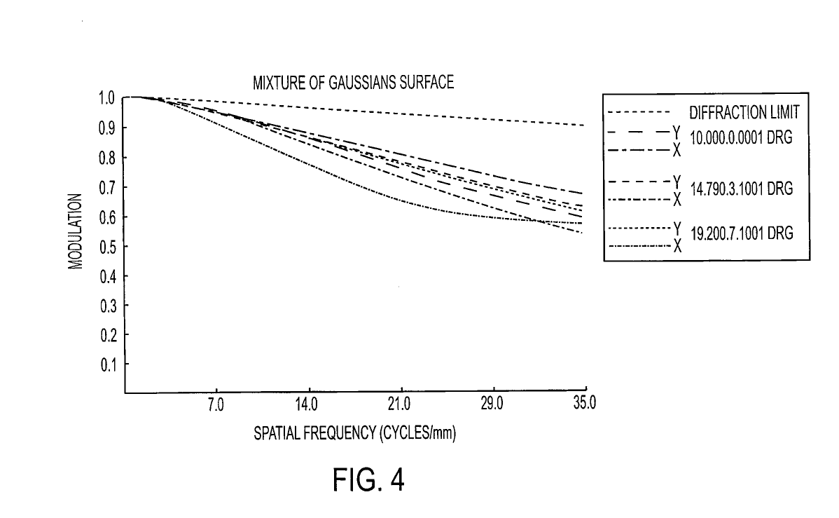

Table 2 shows a comparison of the average tangential and sagittal modulation transfer function (MTF) values and maximum distortion values for the anamorphic asphere, x-y polynomial, Zernike polynomial, and Gaussian solutions, respectively. As is apparent from Table 2, the Gaussian solution achieved the highest MTF value by approximately 20% with an acceptable level of distortion. The MTF for the Gaussian solution is plotted in FIG. 4.

TABLE 2

| | | Max. |
|---|---|---|
| Surface Type | Average MTF | Distortion |
| Anamorphic | 26.5% | 3.8% |
| asphere | | |
| x-y | 43.6% | 2.65% |
| polynomial | | |
| Zernike | 42% | 3.74% |
| polynomial | | |
| Gaussian | 60.5% | 3.6% |

### Example Applications

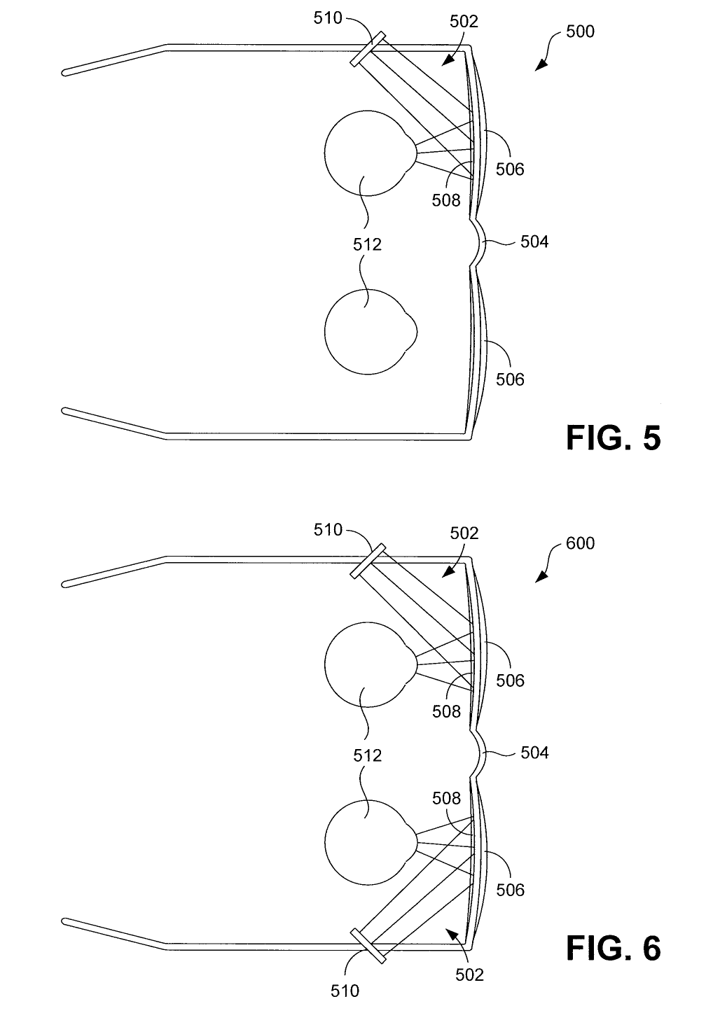

FIGS. 5 and 6 schematically illustrate an application of an optical surface that can be designed using radial basis functions. More particularly, illustrated in FIGS. 5 and 6 is integration of such an optical surface into an eyeglass display device. Beginning with FIG. 5, illustrated is an eyeglass display device 500 having a monocular arrangement in which a single imaging system 502 is incorporated with an eyeglass frame 504. An optical surface 508 designed using the radial basis function approach is integrated with a lens 506 of the device 500. By way of example, the optical surface 508 comprises a partially-mirrored, rotationally non-symmetric surface formed on the inner surface of the lens 506. In use of the device 500, images generated by a microdisplay 510 are reflected by the partially-mirrored, rotationally non-symmetric surface 508 to one of the user's eyes 512. Because the partially-mirrored, rotationally non-symmetric surface 508 is the sole optical element of the system 502, chromatic aberration does not occur and color correction is not needed.

FIG. 6 illustrates an eyeglass display device 600 having a binocular arrangement in which two imaging systems 502 are incorporated into the eyeglass frame 504. In the embodiment of FIG. 6, the eyeglass frame 504 includes two eyeglass lenses 506 that each comprises a partially-mirrored, rotationally non-symmetric surface 508.

### Example System for Designing Optical Surfaces

FIG. 7 is a block diagram illustrating an example architecture for a computing system 700, such as a server, desktop, or laptop computer, that can be used in the design processes described above. In particular, the computing system 700 can provide the computational power that may be needed or desirable to perform the various mathematical functions described in the foregoing. Although a single computer is depicted in FIG. 7, it is to be understood that the functionality provided by that computer can be provided by two or more such computers, for example coupled together in a network environment.

As indicated in FIG. 7, the computing system 700 comprises a processing device 702, memory 704 (i.e., a computer-readable medium), a user interface 706, and at least one I/O device 708, each of which is connected to a local interface 710.

The processing device 704 can include a central processing unit (CPU) or a semiconductor-based microprocessor. The memory 202 includes any one of or a combination of volatile memory elements (e.g., RAM) and nonvolatile memory elements (e.g., hard disk, ROM, flash memory, etc.). The user interface 706 comprises the components with which a user, such as the optical surface designer, interacts with the computing system 700, such as a keyboard, mouse, and a display. The one or more I/O devices 708 are adapted to facilitate communications with other devices and may include one or more communication components such as a modulator/demodulator (e.g., modem), wireless (e.g., radio frequency (RF)) transceiver, network card, etc.

The memory 704 comprises various code including at least an operating system 712 and an optical design program 714. The operating system 712 controls the execution of other programs and provides scheduling, input-output control, file and data management, memory management, and communication control and related services. The optical design program 714 can be used to generate Φ matrices and optimize optical surfaces defined by the Φ matrices relative to selected error functions. To that end, the optical design program 714 can comprise a matrix module 716 that generates Φ matrices, a ray-tracing module 718, an error calculation module 720, and an optimization module 722. In some embodiments, one or more of the ray tracing, error calculation, and optimization functionalities can be provided by routines identical or similar to those comprised by Code V by Optical Research Associates, Zemax by Zemax Development Corp., and Oslo by Sinclair Optics, Inc.

Various code (i.e., logic) has been described. Such code can be stored on any computer-readable medium for use by or in connection with any computer-related system or method. In the context of this document, a “computer-readable medium” is an electronic, magnetic, optical, or other physical device or means that contains or stores code, such as a computer program, for use by or in connection with a computer-related system or method. The code can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

Reference is now made to FIG. 8, which provides clarification as to some of the terminology that has been used in this disclosure. FIG. 8 illustrates an example surface 800 that comprises a plurality of data values 802, which correspond to data sites 806 on a plane 804. As shown in FIG. 8, an evaluation point 808 can lie within the data sites 806 (i.e., not necessarily coincident with the data sites).

1. A method for designing an optical surface, the method comprising:
constructing a matrix of radial basis functions, each column of the matrix corresponding to a radial basis function;
selecting an initial surface to be used as a starting point;
selecting initial weights for the radial basis functions;
generating an initialized optical surface based upon the selected initial surface and initial weights; and
optimizing the initialized optical surface to minimize an error function.

2. The method of claim 1, wherein constructing a matrix of radial basis functions comprises constructing a matrix of radial basis functions in which the number of rows of the matrix correspond to a number of data sites to be considered.

3. The method of claim 1, wherein the matrix is a Φ matrix defined by:
$$Φ = [ \begin{matrix}{φ}_{0} ( {x}_{1} ) & {φ}_{1} ( {x}_{1} ) & … & {φ}_{n} ( {x}_{1} ) \\ {φ}_{0} ( {x}_{2} ) & {φ}_{1} ( {x}_{2} ) & … & {φ}_{n} ( {x}_{2} ) \\ ⋮ & ⋮ & ⋱ & ⋮ \\ {φ}_{0} ( {x}_{m} ) & {φ}_{1} ( {x}_{m} ) & … & {φ}_{n} ( {x}_{m} )\end{matrix} ]$$
where φᵢ are radial basis functions and xᵢ are evaluation points or data sites of an optical surface.

4. The method of claim 1, wherein the matrix of radial basis functions, the weights, and the optical surface are related to each other by:
Φw=Z
where Φ is the matrix of radial basis functions, w is a vector of weights, and Z is the initialized optical surface.

5. The method of claim 1, wherein selecting an initial surface comprises prompting a human user to select the initial surface.

6. The method of claim 1, wherein selecting an initial surface comprises selecting a base conic as the starting point.

7. The method of claim 1, wherein selecting an initial surface comprises selecting a flat surface as the starting point.

8. The method of claim 1, wherein selecting initial weights comprises prompting a human user to select the initial weights.

9. The method of claim 1, wherein selecting initial weights comprises setting the weights to zero.

10. The method of claim 1, wherein optimizing the initialized surface comprises calculating the error of the initialized optical surface using the error function and then:
(a) changing the weights of the radial basis functions;
(b) computing a new optical surface using the new weights;
(c) calculating the error of the new optical surface using the error function; and
(d) repeating actions (a)-(c).

11. The method of claim 10, wherein computing a new optical surface comprises computing a new optical surface using the relation:
Φw=Z
where Φ is the matrix of radial basis functions, w is a vector of weights, and Z is the new optical surface.

12. The method of claim 10, further comprising comparing the calculated errors of the optical surfaces and selecting the optical surface exhibiting the smallest error.

13. The method of claim 1, further comprising selecting the error function.

14. The method of claim 13, wherein selecting the error function comprises prompting a human user to select the error function.

15. The method of claim 13, wherein selecting an error function comprises selecting one of transverse error, Strehl ratio, or modulation transfer function as the error function.

16. The method of claim 1, further comprising selecting a number of radial basis functions to use to construct the matrix of radial basis functions.

17. The method of claim 16, wherein selecting a number of radial basis functions comprises prompting a human user to select the number of radial basis functions.

18. The method of claim 1, further comprising selecting a number of data sites to use to construct the matrix of radial basis functions.

19. The method of claim 18, wherein selecting a number of data sites comprises prompting a human user to select a number of data sites to use to construct the matrix of radial basis functions.

20. The method of claim 1, further comprising selecting a type of radial basis function to use to construct the matrix of radial basis functions.

21. The method of claim 20, wherein selecting a type of radial basis function comprises prompting a human user to select the type of radial basis function.

22. The method of claim 20, wherein selecting a type of radial basis function comprises selecting a Gaussian function, an inverse multiquadric function, a thin-plate spline, a Wendland function, or a Wu function.

23. A method for designing an optical surface, the method comprising:
constructing a Φ matrix of radial basis functions, the matrix being defined by:
$$Φ = [ \begin{matrix}{φ}_{0} ( {x}_{1} ) & {φ}_{1} ( {x}_{1} ) & … & {φ}_{n} ( {x}_{1} ) \\ {φ}_{0} ( {x}_{2} ) & {φ}_{1} ( {x}_{2} ) & … & {φ}_{n} ( {x}_{2} ) \\ ⋮ & ⋮ & ⋱ & ⋮ \\ {φ}_{0} ( {x}_{m} ) & {φ}_{1} ( {x}_{m} ) & … & {φ}_{n} ( {x}_{m} )\end{matrix} ]$$
where φᵢ are radial basis functions and xᵢ are evaluation points or data sites of an optical surface;
selecting an initial surface to be used as a starting point;
selecting initial weights for the radial basis functions;
generating an initialized optical surface based upon the selected initial surface and initial weights; and
optimizing the initialized optical surface to minimize an error function by:
(a) changing the weights of the radial basis functions,
(b) computing a new optical surface using the relation:
Φw=Z
where w is a vector of weights, and Z is the new optical surface,
(c) calculating the error of the new optical surface using the error function, and
(d) repeating actions (a)-(c).

24. The method of claim 23, wherein selecting an initial surface comprises selecting a base conic a flat surface as the starting point.

25. The method of claim 23, wherein selecting initial weights comprises setting w to zero.

26. The method of claim 23, wherein the radial basis function is a Gaussian function, an inverse multiquadric function, a thin-plate spline, a Wendland function, or a Wu function.

27. The method of claim 23, wherein the error function is transverse error, Strehl ratio, or modulation transfer function.

28. The method of claim 23, further comprising comparing the calculated errors of the optical surfaces and selecting the optical surface exhibiting the smallest error.

29. A computer-readable medium that stores:
logic configured to construct a matrix of radial basis functions, each column of the matrix corresponding to a radial basis function;
logic configured to select an initial surface to be used as a starting point;
logic configured to select initial weights for the radial basis functions;
logic configured to generate an initialized optical surface based upon the selected initial surface and initial weights; and
logic configured to optimize the initialized optical surface to minimize an error function.

30. The computer-readable medium of claim 29, wherein the logic configured to construct a matrix is configured to construct a Φ matrix defined by:
$$Φ = [ \begin{matrix}{φ}_{0} ( {x}_{1} ) & {φ}_{1} ( {x}_{1} ) & … & {φ}_{n} ( {x}_{1} ) \\ {φ}_{0} ( {x}_{2} ) & {φ}_{1} ( {x}_{2} ) & … & {φ}_{n} ( {x}_{2} ) \\ ⋮ & ⋮ & ⋱ & ⋮ \\ {φ}_{0} ( {x}_{m} ) & {φ}_{1} ( {x}_{m} ) & … & {φ}_{n} ( {x}_{m} )\end{matrix} ]$$
where φᵢ are radial basis functions and xᵢ are evaluation points or data sites of an optical surface.

31. The computer-readable medium of claim 29, wherein the matrix of radial basis functions, the weights, and the optical surface are related to each other by:
Φw=Z
where Φ is the matrix of radial basis functions, w is a vector of weights, and Z is the initialized optical surface.

32. The computer-readable medium of claim 29, wherein the logic configured to select an initial surface is configured to select a base conic or a flat surface as the starting point.

33. The computer-readable medium of claim 29, wherein the logic configured to select initial weights is configured to set the weights to zero.

34. The computer-readable medium of claim 29, wherein the logic configured to optimize is configured to calculate the error of the initialized optical surface using the error function and then:
(a) change the weights of the radial basis functions;
(b) compute a new optical surface using the new weights;
(c) calculate the error of the new optical surface using the error function; and
(d) repeat actions (a)-(c).

35. The computer-readable medium of claim 34, wherein the logic configured to optimize is configured to compute a new optical surface using the relation:
Φₘₓₙw=Z
where Φ is the matrix of radial basis functions, w is a vector of weights, and Z is the new optical surface.

36. The computer-readable medium of claim 29, further comprising logic configured to compare the calculated errors of the optical surfaces and to select the optical surface exhibiting the smallest error.

37. The computer-readable medium of claim 29, further comprising logic configured to select transverse error, Strehl ratio, or modulation transfer function as the error function.

38. The computer-readable medium of claim 29, further comprising logic configured to select a number of radial basis functions to use to construct the matrix of radial basis functions.

39. The computer-readable medium of claim 29, further comprising the logic configured to select a number of data sites to use to construct the matrix of radial basis functions.

40. The computer-readable medium of claim 29, further comprising the logic configured to select a type of radial basis function to use to construct the matrix of radial basis functions as a Gaussian function, an inverse multiquadric function, a thin-plate spline, a Wendland function, or a Wu function.
